(19) United States
(12) Patent Application Publication
(10) Pub. No.: US 2015/0167880 A1
(43) Pub. Date: Jun. 18, 2015

(54) COUPLING AND CLIP FOR COUPLING

(71) Applicants: Hyundai Motor Company, Seoul (KR); Kia Motors Corporation, Seoul (KR); Yushinprecisionindustrial Co., Ltd., Incheon (KR)

(72) Inventors: Jai Young AN, Suwon-si (KR); Joon Sik HWANG, Incheon (KR); Young Jin KIM, Incheon (KR); Ju Ho LEE, Seoul (KR)

(73) Assignees: Hyundai Motor Company, Seoul (KR); Kia Motors Corporation, Seoul (KR); Yushinprecisionindustrial Co., Ltd., Incheon (KR)

(21) Appl. No.: 14/489,009

(22) Filed: Sep. 17, 2014

(30) Foreign Application Priority Data
Dec. 12, 2013 (KR) 10-2013-0154971

(51) Int. Cl. F16L 37/12; F16L 21/08

(52) U.S. Cl. CPC F16L 37/1225; F16L 21/08

(57) ABSTRACT

Disclosed are a coupling and a clip for a coupling. The coupling may include a male connector having a holding groove, a female connector having a head portion for inserting the male connector, and a clip detachably coupled to the female connector and securing the male connector to the female connector. The female connector may include at least a slit and a coupling recess for inserting and seating the clip. The clip may include a band with elastically movable fore ends. The band may include at least a portion to serve as a locking portion, which is projected to an inside of the female connector through the at least a slit of the female connector and inserted in the holding groove of the male connector. One fore end of the band may form a hand grip and the other may serve as a rotation center when the hand grip is pulled outwards.

### CROSS-REFERENCE TO RELATED APPLICATION

The present application claims priority of Korean Patent Application Number 10-2013-0154971 filed on Dec. 12, 2013, the entire contents of which application are incorporated herein for all purposes by this reference.

### BACKGROUND OF INVENTION

1. Field of Invention

The present invention relates to a coupling used in a vehicle for connecting a hose for transferring a pressure fluid, and a clip therefor.

2. Description of Related Art

Recently, in order to improve workability, a coupling has been developed and used for quick and convenient connection of the hose. For example, in a case of a radiator hose which connects between an engine and a radiator in the vehicle, a coupling is mounted to a fore end of the hose and an inlet of the engine for connecting the hose to the inlet, simply.

The coupling has a female connector and a male connector for coupling the connectors inserted to each other, and a clip is coupled to the male connector for locking/unlocking the female connector. Accordingly, by mounting the female connector to the radiator hose, and mounting the male connector to the engine inlet, and only by inserting the female connector on the hose to the male connector, the hose can be connected to the engine inlet, simply.

The clip is assembled to the female connector. The clip is inserted in a holding groove formed in an outside circumference of the male connector to lock or unlock the inlet and the connector in a tightly coupled state.

The clip, a member having its own elastic force and stiffness, is made to be caught at the holding groove when a portion of the clip projected to an inside of the connector is opened elastically, and returns to an original position when the holding groove in the male connector passes the projected portion at the time the male connector is coupled to the female connector. Accordingly, once the male connector is inserted in the female connector, a coupled state of the coupling is maintained as the holding groove in the male connector is caught by the clip, and, if required, by separating the clip from the holding groove, the coupling may be separated.

Thus, the clip, an element for fastening the coupling actually, is required, not only to secure fastening force adequately, but also to have good assemblability with the female connector. Particularly, it is required that handling of the clip is convenient enough to lock or unlock the coupling without interference with surrounding elements in a case the clip is used in a small space like an engine compartment of the vehicle.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

The present invention has been made in an effort to provide a coupling and a clip for a coupling having advantages of simple to assemble, easy to handle, and to prevent defective fastening and enhance air tightness.

Accordingly, the present invention is directed to provide a coupling and a clip for a coupling which is simple to assemble and easy to handle enough to use even in a small place like an engine compartment of a vehicle having an intensive interference with surroundings. Moreover, the present invention is directed to provide a coupling and a clip for a coupling in which a connector and a clip are coupled more firmly and precisely, to prevent defective fastening and enhance air tightness.

In various aspects, a coupling may include a male connector having a holding groove formed in a fore end outside circumference thereof, a female connector having a head portion for inserting the male connector therein in an axial direction to couple to the male connector, and a clip detachably coupled to the female connector and securing the male connector to the female connector, wherein the female connector includes at least a slit and a coupling recess formed along an outside circumference of the female connector and connected to the at least a slit for inserting and seating the clip, the clip includes a band formed to surround the outside circumference of the female connector and have opposite fore ends which are elastically movable in a transverse direction plane of the female connector, the band includes at least a portion to serve as a locking portion, which is projected to an inside of the female connector through the at least a slit of the female connector and inserted in the holding groove of the male connector for securing the male connector, one side fore end of the band is projected outwards to form a hand grip, and the other side fore end of the band is caught at a step formed on the coupling recess of the female connector to serve as a rotation center of the band when the hand grip is pulled outwards.

The at least a slit may include two slits and the band may include two linear locking portions arranged opposite to each other to pass the slits in the female connector respectively, a bendable connection portion connected between the two locking portions to generate elastic force, and the opposite fore ends bent in opposite directions from the two locking portions. The band may have a lengthy band shape with a width larger than a thickness thereof.

One or each of the locking portions may be extended in a straight line to cross the inside of the female connector in a form of a chord. The hand grip at the one side fore end of the band may be curved in a form of an arc. The slit may be formed opposite to each other at a substantially 180° interval with reference to a center of the female connector, and the locking portions may be formed at positions in accord to the slits.

Thus, by improving operability of the clip, the coupling and the clip for a coupling in accordance with various aspects has an advantage of convenience in use. Moreover, the simple separation and assemblability of the clip from/to the female connector permits easy repair and maintenance, in the future. Furthermore, the precise assembly of the clip to the female connector without clearance permits more firm fastening of the coupling and to enhance air-tightness.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 illustrates a perspective view of an exemplary coupling in accordance with the present invention.

FIG. 2 illustrates a cross-sectional view showing a coupled state of an exemplary coupling in accordance with the present invention.

FIG. 3 illustrates a perspective view showing a state in which a clip is being mounted to a female connector in an exemplary coupling in accordance with the present invention.

FIG. 4 illustrates a cross-sectional view showing a female connector having a clip mounted thereto in an exemplary coupling in accordance with the present invention.

FIGS. 5A-5C illustrate drawings showing a process of unlocking of a clip from a female connector in an exemplary coupling in accordance with the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Wherever possible, the same or like parts in the drawing will be given the same reference numerals. The terms in this specification have been selected only for description of the embodiments, but not for limiting subject matters of the present invention with meanings of the terms themselves.

A singular expression in this specification includes a plural expression as far as the singular expression is not singular in view of a context of a passage, obviously. The word of “include” used in this specification specifies particular characteristic, region, integer, step, action, element and/or component, but does not exclude existence or addition of other particular characteristic, region, integer, step, action, element, component, and/or group.

All of the terms including technical and scientific terms used hereinafter have meanings the same with meanings generally understood by persons skilled in this field of art. It is required that words and terms defined in a dictionary will not be interpreted as an ideal or very official meaning as far as the words or terms are interpreted and defined to meet description disclosed, presently.

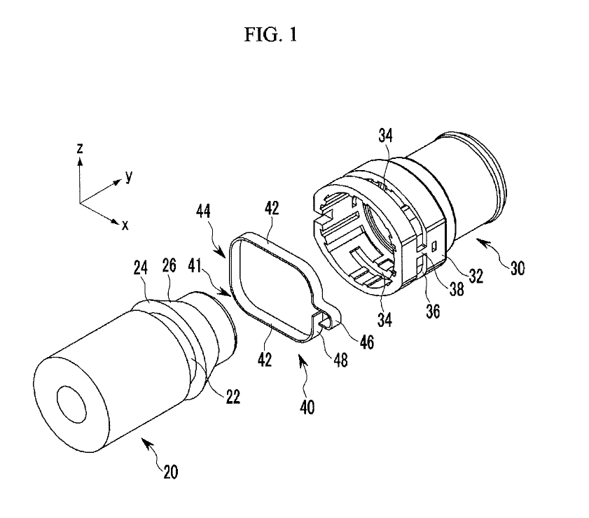

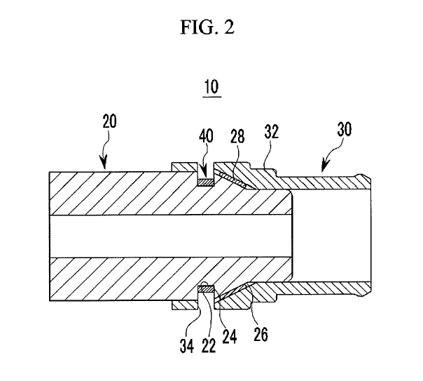

FIG. 1 illustrates a perspective view of a coupling in accordance with various embodiments of the present invention, and FIG. 2 illustrates a cross-sectional view showing a coupled state of a coupling in accordance with various embodiments of the present invention.

Exemplary embodiments will be described taking a coupling used for connecting a radiator hose which connects an engine to a radiator in a vehicle as an example. Of course, the present invention is not limited to connection of a radiator hose in a vehicle, but applicable to any place where transfer of a fluid is required in different devices.

The coupling 10 according to various embodiments of the present invention includes one pair of a male connector 20 and a female connector 30 to be coupled to each other, and a clip 40 for locking/unlocking the male connector 20 inserted in the female connector 30.

For example, the male connector 20 may be mounted to an engine inlet and the female connector 30 may be mounted to a fore end of a radiator hose. Accordingly, upon inserting the male connector 20 in the female connector 30 to couple the coupling 10, the radiator hose is connected to the engine inlet, readily.

The male connector 20 has a cylindrical shape with a rear side fore end to be coupled to the engine inlet and a front side fore end to be inserted in the female connector 30. The male connector 20 has a front side having a holding groove 22 formed in an outside circumference thereof for having the clip 40 inserted therein. The holding groove 22 is an inward recess with a perpendicular or substantially perpendicular inner side to form a step 24. Accordingly, the clip 40 placed in the holding groove 22 is caught at the step 24 preventing the clip 22 from escaping to an outside of the holding groove 22.

And, the male connector 20 has a front side of the holding groove 22 with a truncated cone formed in an axial direction to have a diameter which becomes smaller gradually as the truncated cone goes forward to form a sloped surface 26. Accordingly, in a process the male connector 20 passes the clip 40 mounted to the female connector 30, the male connector 20 can proceed forward without interference with the clip 40 as the clip 40 is opened elastically according to the sloped surface 26. The clip 40 is inserted in the holding groove 22 as a portion of the clip 40 opened by the elastic force returns to an original state after the clip 40 is passed through the sloped surface.

A front shape of the male connector 20 may have a variety of shapes, and has no particular limitation.

In this case, the axial direction is a y-axis direction in FIG. 1 which is a coupling direction of the female connector 30 and the male connector 20. And, in description made hereinafter, a transverse direction is a direction perpendicular to the axial direction, and a transverse plane is an xz plane in FIG. 1 formed in the transverse direction.

The female connector 30 has a cylindrical shape having a rear side fore end coupled to the hose inserted therein in the axial direction and a front fore end with a head portion 32 provided thereto in which the male connector 20 is inserted in the axial direction.

The head portion 32 of the female connector 30 has an inside formed in conformity with the fore end of the male connector 20 for making tight coupling with the male connector 20. In some embodiments, the inside of the head portion 32 of the female connector 30 has a circular or substantially circular cross section in conformity with the male connector 20.

The female connector 30 may additionally have an o-ring 28 mounted to the inside to be pressed by the male connector 20 to maintain air-tightness.

The female connector 30 has a coupling recess 36 in an outside circumference thereof for inserting and seating the clip 40 thereon. And, the female connector 30 has a slit 34 formed therein, which is a portion opened in the female connector 30 along the coupling recess 36 in a predetermined length to make an inside and the outside of the female connector 30 in communication. The coupling recess 36 and the slit 34 are portions the clip 40 is to be mounted thereon, which will be described again later.

Accordingly, referring to FIG. 2, if the male connector 20 is inserted in the head portion 32 of the female connector 30, the coupling 10 is coupled as the clip 40 coupled to the female connector 30 is inserted in the holding groove 22 in the male connector 20. And, the clip 40 is inserted in the holding groove 22 in the male connector 20 to maintain a locked state of the male connector 20 to the female connector 30.

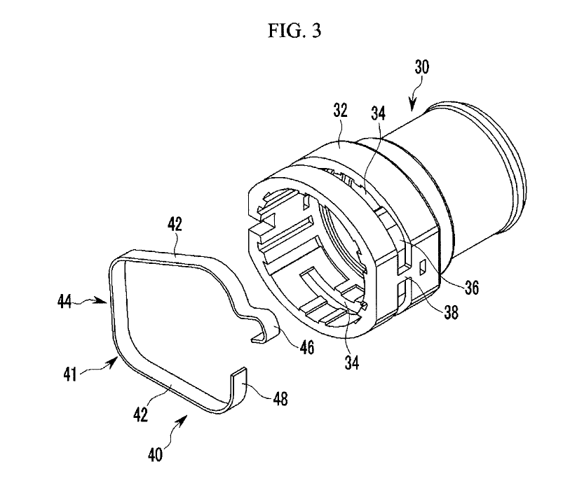

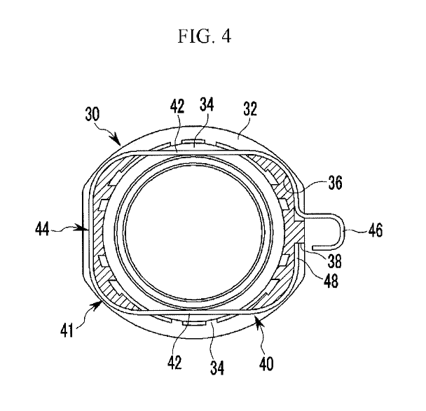

Referring to FIGS. 3 and 4, a coupling structure of the clip to the female connector will be described.

The clip 40 is detachably coupled to the head portion 32 of the female connector 30 to have a portion thereof projected to an inside of the female connector 30 through the slit 34 inserted in the holding groove 22 in the male connector 20.

The clip 40 includes a band 41 formed to surround an outside circumference of the head portion 32 of the female connector 30 so as to be elastically deformed in a transverse plane of the female connector 30 to make opposite fore ends thereof move apart. The band 41 may be formed of a material having its own elastic force. For example, the band may be formed of spring steel.

The band 41 has a lengthy band shape with a width larger than a thickness and a length enough to surround the head portion 32 along the coupling recess 36 formed in the head portion 32 of the female connector 30, substantially. The width is a width of the band 41 in an axial direction.

The band 41 has at least a portion thereof which forms a locking portion 42 projected to the inside of the female connector 30 through the slit 34 in the female connector 30 inserted in the holding groove 22 in the male connector 20. According to this, as the locking portion 42 of the band 41 is caught at the holding groove 22 in the male connector 20, the female connector 30 and the male connector 20 are secured in the locked state.

The head portion 32 of the female connector 30 has the slit 34 formed passed therethrough in a predetermined length along the coupling recess 36. Accordingly, when the band 41 is inserted in the coupling recess 36, a linear shape of the locking portion 42 passes the slit 34 in a form of a chord. Accordingly, the locking portion 42 is projected to the inside of the female connector 30 in a mode of crossing an inside circumference of the head portion 32 of the female connector 30.

In some embodiments, the female connector 30 secures the male connector 20 at two places with the clip 40. Therefore, the female connector 30 may have two slits 34 formed opposite to each other at or substantially at an 180° interval with reference to a center of the female connector 30, and the band 41 may also have the locking portion 42 formed at positions matched to the slits 34.

For this, the band 41 includes two linear locking portions 42 arranged opposite to each other to pass the slits 34 in the female connector 30 respectively, a bendable connection portion 44 connected between the two locking portions 42 to generate the elastic force, and opposite fore ends of the band 41 bent from the locking portions 42 opposite to each other, respectively.

As described herein, the locking portion 42 holds the holding recess 22 in the male connector 20 to secure the male connector 20, and the bendable connection portion 44 applies elastic restoring force to the band 41 as the bendable connection portion 44 bends elastically when the opposite fore ends of the band 41 move apart.

The opposite fore ends of the band 41 bend from the locking portions 42 and extend to ends of the coupling recesses 36, respectively. One side of the opposite fore ends of the band 41 in various embodiments is projected outwards from the female connector 30 to form a hand grip 46. In various embodiments, the hand grip 46 may have a structure in which the fore end of the band 41 is bent a plurality of times to form a smooth curve in a form of an arc. If the hand grip 46 has such a structure, worker's gripping on the hand grip 46 will be convenient, and, since the arc formed curve portion is easy to insert a tool therein, work using the tool can also be carried out, easily.

And, the other side 48 of the opposite fore ends of the band 41 is extended to a step 38 of the coupling recess. The other side 48 of the opposite fore ends of the band 41 extended to the step 38 at the coupling recess 36 is supported on the step 38 such that the step 38 becomes a rotation center of the band 41 when the band 41 is rotated in the transverse direction.

In some embodiments, the band 41 forms a rectangular or substantially rectangular form as portions between the locking portions 42, the bendable connection portion 44, and the opposite fore ends are bent, respectively. The holding groove 22 in the male connector 20 is also formed in conformity with a form of the band 41 such that the band 41 is inserted in, and coupled to the holding groove 22, exactly.

Accordingly, referring to FIG. 3, if the band 41 is moved toward the coupling recess 36 in the head portion 32 of the female connector 30 in a state the opposite fore ends of the band 41 are moved apart to open a space between the two locking portions 42 adequately, the female connector 30 is coupled to the clip 40 as the band 41 is seated on the coupling recess 36.

And, referring to FIG. 4, when the clip 40 is mounted to the female connector 30, the band 41 is inserted in the coupling recess 36, and the two locking portions 42 arranged opposite to each other cross the inside circumference of the head portion 32 in a form of a chord passed through the inside of the female connector 30.

Thus, the coupling according to various embodiments of the present invention can carry out assembly between the female connector and the clip more easily as the clip 40 is mounted to an outside of the female connector 30. And, as the clip is assembled to the outside of the female connector, the band can be mounted to the coupling recess in the female connector easily by opening the clip even if a width of the coupling recess 36 is formed to match with the width of the band 41 without clearance, precisely. According to this, since the band 41 can be coupled to the female connector 30 precisely without movement, and the band 41 does not move in a width direction of the female connector 30, fastening force and air-tightness of the coupling can be enhanced.

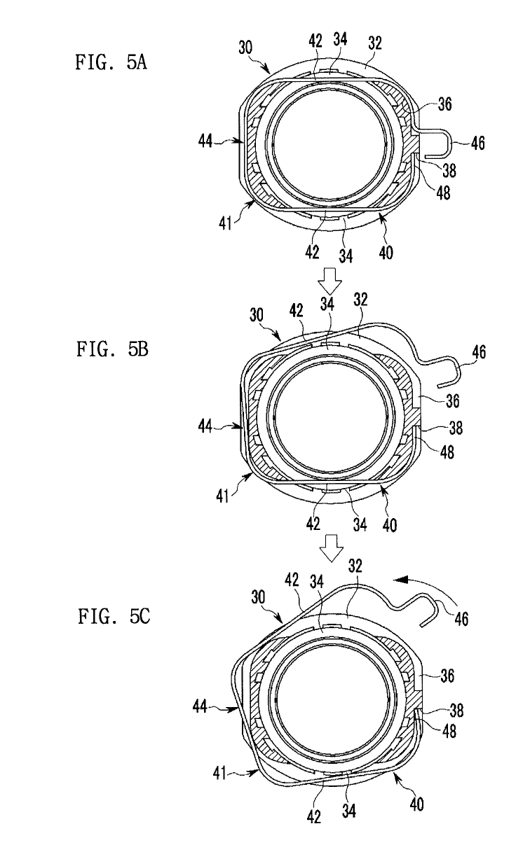

Referring to FIGS. 5A-5C, a process for releasing a locked state of the clip 40 from the female connector 30 will be described.

In a state the coupling 10 is coupled such that the clip 40 on the female connector 30 secures the male connector 20 in the locked state, if it is intended to decouple the coupling 10, it is required to make the locking portions 42 of the clip 40 to breakaway from the holding groove 22 in the male connector 20.

The coupling 10 enables to release the locked state of the male connector 20 from the clip 40 simply by pulling the hand grip 46 of the clip 40 coupled to the female connector 30 to rotate the clip 40 in the transverse plane.

Referring to FIGS. 5A-5C, in the locked state, the locking portion 42 of the clip 40 is projected to the inside of the female connector 30. In this state, if the hand grip 46 is pulled, the opposite fore ends of the band 41 of the clip 40 move apart, to lift up the locking portion 42 connected to the hand grip 46 from the female connector 30 at first, moving the locking portion 42 connected to the hand grip 46 to an outside of the female connector 30. And, if the hand grip 46 is pulled continuously, the bendable connection portions 44 between the locking portions 42 bend elastically, rotating the band 41 in the transverse direction plane (e.g., the xz-plane in FIG. 1), taking the other side fore end 48 of the band 41 supported on the step 38 of the coupling recess 36 as an axis.

As the band 41 itself makes relative rotation with respect to the female connector 30, a position of the locking portion 42 of the band 41 becomes not to meet with a position of the slit 34 in the female connector 30. Accordingly, as both of the two locking portions 42 of the band 41 are spaced from the slits 34 respectively, the band 41 moves to an outside of the female connector 30. Accordingly, as the locking portions 42 of the band 41 are separated from the holding groove 22 in the male connector 20, the locked state of the male connector 20 on the female connector 30 is released.

Thus, the locked state of the coupling 10 is released as the band 41 rotates with respect to the female connector 30. This structure provides convenience of working in a very complicate and small space like an engine compartment of a vehicle. That is, since the coupling is required, not removal of the clip, but only simple rotation of the clip for decoupling, a working radius required for releasing the locking of the clip can be minimized.

For convenience in explanation and accurate definition in the appended claims, the terms “front” or “rear”, “inside” or “outside”, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A coupling comprising:
a male connector having a holding groove formed in a fore end outside circumference thereof;
a female connector having a head portion for inserting the male connector therein in an axial direction to couple to the male connector; and
a clip detachably coupled to the female connector and securing the male connector to the female connector, wherein
the female connector includes at least a slit and a coupling recess formed along an outside circumference of the female connector and connected to the at least a slit for inserting and seating the clip,
the clip includes a band formed to surround the outside circumference of the female connector and have opposite fore ends which are elastically movable in a transverse direction plane of the female connector,
the band includes at least a portion to serve as a locking portion, which is projected to an inside of the female connector through the at least a slit of the female connector and inserted in the holding groove of the male connector for securing the male connector,
one side fore end of the band is projected outwards to form a hand grip, and
the other side fore end of the band is caught at a step formed on the coupling recess of the female connector to serve as a rotation center of the band when the hand grip is pulled outwards.

2. The coupling of claim 1, wherein the band has a lengthy band shape with a width larger than a thickness thereof.

3. The coupling of claim 2, wherein:
the at least a slit includes two slits, and
the band includes two linear locking portions arranged opposite to each other to pass the slits in the female connector respectively, a bendable connection portion connected between the two locking portions to generate elastic force, and the opposite fore ends bent in opposite directions from the two locking portions.

4. The coupling of claim 3, wherein one or each of the locking portions is extended in a straight line to cross the inside of the female connector in a form of a chord.

5. The coupling of claim 4, wherein the slits are formed opposite to each other at a substantially 180° interval with reference to a center of the female connector, and the locking portions are formed at positions in accord to the slits.

6. The coupling of claim 5, wherein the hand grip at the one side fore end of the band is curved in a form of an arc.

7. A clip for a coupling, wherein the coupling includes a male connector and a female connector, and the clip is detachably coupled to the female connector and securing the male connector to the female connector, the clip comprising:
a band formed to surround an outside circumference of the female connector and have opposite fore ends which are elastically movable in a transverse direction plane of the female connector, wherein
the male connector has a holding groove formed in a fore end outside circumference thereof,
the female connector has a head portion for inserting the male connector therein in an axial direction to couple to the male connector, and includes at least a slit and a coupling recess formed along the outside circumference of the female connector and connected to the at least a slit for inserting and seating the clip,
the band includes at least a portion to serve as a locking portion, which is projected to an inside of the female connector through the at least a slit of the female connector and inserted in the holding groove of the male connector for securing the male connector,
one side fore end of the band is projected outwards to form a hand grip, and
the other side fore end of the band is caught at a step formed on the coupling recess of the female connector to serve as a rotation center of the band when the hand grip is pulled outwards.

8. The clip of claim 7, wherein the band has a lengthy band shape with a width larger than a thickness thereof.

9. The clip of claim 8, wherein:
the at least a slit includes two slits, and
the band includes two linear locking portions arranged opposite to each other to pass the slits in the female connector respectively, a bendable connection portion connected between the two locking portions to generate elastic force, and the opposite fore ends bent in opposite directions from the two locking portions.

10. The clip of claim 9, wherein one or each of the locking portions is extended in a straight line to cross the inside of the female connector in a form of a chord.

11. The clip of claim 10, wherein the hand grip at the one side fore end of the band is curved in a form of an arc.
